(19) United States
(12) Patent Application Publication
(10) Pub. No.: US 2003/0228900 A1
(43) Pub. Date: Dec. 11, 2003

(54) Charge management system

(75) Inventor: Junichi Yamagishi, Taito-ku (JP)

Correspondence Address: JORDAN AND HAMBURG LLP, 122 EAST 42ND STREET, SUITE 4000, NEW YORK, NY, 10168, US

(73) Assignee: Unirec Co., Ltd., Taito-ku (JP)

(21) Appl. No.: 10/165,243

(22) Filed: Jun. 7, 2002

(51) Int. Cl. A63F 13/00

(52) U.S. Cl. 463/25

(57) ABSTRACT

The object of the present invention is to enable the player to start very easily the operation of game machines. In order to achieve this end, the charge management system of the present invention comprises game machines 1, 3 provided with fingerprint information inputting section 5, 7, a MPU 13 connected through wire or by radio with the game machines 1, 3, a fingerprint information registration section 17 and card information inputting section 19, a charging information data base 23, a card manager 31 communicable through phone line 29 and a card information data base 23. When card information is inputted and fingerprint information is registered, the information is transmitted to the card manager 31 to be collated with the card information contained in the card information data base 33. When the collated results agree, an approval signal is transmitted from the card manager 31 to the MPU 13. When the fingerprint information inputted in the fingerprint information inputting section 5 and/or 7 agrees with the fingerprint information registered, the game machine 1 and/or 3 is brought into the operable condition. Then, in response with the operation information and based on the charging information, the player is charged and the charging result is transmitted to the card manager.

### BACKGROUND OF THE INVENTION

1. Field of Invention

The present invention relates to a charge management system designed to manage the charges of game machines and other objects of operation installed in amusement arcade.

2. Description of the Related Art

In the past when a game is played with a game machine installed in a amusement arcade, the operator or player inserts a coin or coins such as 100 Yen coin into the slot of the machine to start a game. To play a plurality of times on this game machine, a plurality of coins are necessary. Keeping them always in the hands of the operator is troublesome, and keeping on playing while changing money by means of a money changer is also troublesome.

In recent years, on the other hand, as described in Japanese Patent Application Laid Open 05-146555 and Japanese Patent Application Laid Open 07-171240, there have developed systems in which prepaid cards, membership cards or credit cards are used to allow playing without keeping coins in hands.

However, when a credit card or other cards are used, it will be necessary to input the card information and the password number of the credit card every time when a game machine is used, and the starting operation risks to be troublesome. In addition, it will be necessary to take out a credit card every time, which will involve the risk of losing the credit card.

### SUMMARY OF THE INVENTION

The present invention provides a charge management system facilitating the operation of a machine by an operator by means of a simple management and capable of reducing the risk of losing cards.

A first aspect of the present invention provides a charge management system, having an object or objects of operation comprising a bio-information inputting section for inputting the bio-information of the operator, a processing means connected through wire or by radio with the object or objects of operation, a bio-information registration section connected with the processing means for registering the bio-information of the operator, and a card information inputting section for inputting card information, a charging information data base connected with the processing section for storing the charging information of the object or objects of operation, a card manager capable of communicating through a telephone with the processing means, and a card information data base connected with the card manager for storing the card information. When the card information is inputted and the bio-information is registered in the processing means, the information is transmitted to the card manager to be collated with the card information contained in the card information data base. When an approval signal is transmitted from the card manager to the processing means based on the result of the collation, and when the bio-information inputted in the bio-information inputting section of the object or objects of operation agrees with the registered bio-information, the processing means brings the object or objects of operation into an operable condition and the price is charged based on the charging information in response to the operation information of the object or objects of operation and the charge result is transmitted to the card manager.

In the charge management system of the first aspect, a second aspect of the present invention, wherein the objects of operation are of plural types or are plural in number.

In the charge management system of the first and second aspects, a third aspect of the present invention, wherein the bio-information is the fingerprint information of the operator.

In the charge management system of any one of the first to third aspects, a fourth aspect of the present invention, wherein the processing means transmits the charge results every time or collectively.

In the charge management system of any one of the first to fourth aspects, a fifth aspect of the present invention, wherein a printer is connected with the processing means to print out the charge results for the information of the operator.

According to the first aspect, the charge management system includes an object or objects of operation comprising a bio-information inputting section for inputting the bio-information of the operator, a processing means connected through wire or by radio with the object or objects of operation, a bio-information registration section connected with the processing means for registering the bio-information of the operator, and a card information inputting section for inputting card information, a charging information data base connected with the processing section for storing the charging information of the object or objects of operation; a card manager capable of communicating through a telephone with the processing means, and a card information data base connected with the card manager for storing the card information. When the card information is inputted and the bio-information is registered in the processing means, the information is transmitted to the card manager to be collated with the card information contained in the card information data base. When an approval signal is transmitted from the card manager to the processing equipment based on the collated result, and when the bio-information inputted in the bio-information inputting section of the object or objects of operation agrees with the registered bio-information, the processing means brings the object or objects of operation into an operable condition and the player is charged based on the charging information in response to the operation information of the object or objects of operation and the charge result is transmitted to the card manager. Thus, the operator can operate the game machine only by inputting the card information and by registering the bio-information once, and thereafter by inputting the bio-information in the bio-information inputting section of the object or objects of operation. Therefore, the operator can enjoy the operation of game machines by means of very simple operation. In addition, since it is possible to operate game machines by inputting only once the card information and without inputting the card information thereafter, there is no need of taking out a card every time, thus reducing remarkably the risk of losing cards.

In addition to the effects of the first aspect, the second aspect provides the objects of operation to plural types or a plural number. When the operator operates plural types or a plural number of objects of operation, therefore, plural types or a plural number of objects of operation can be operated by inputting the card information or registering the bio-information only once and thereafter by inputting only the bio-information. Thus plural types or a plural number of game machines can be operated very simply.

In addition to the effects of the first and second aspects, the third aspect uses the fingerprint information of the operator for the bio-information. Therefore, the operator can start the operation of the object or objects of operation by registering his or her fingerprint information once and by simply inputting the fingerprint information thereafter, and thus the operation of the object or objects of operation can be started very easily.

In addition to the effects of any of the first to third aspects, the fourth aspect employs the processing means that transmits the charge results every time or collectively, and therefore the card manager can process the charge results without any problem.

In addition to the effects of any of the first to fourth aspects, the fifth aspect employs a printer connected with the processing means to print out the charge result for the information of the operator. Therefore, the operator can easily find out the charge result after completing the operation of the object or objects of operation.

### BRIEF DESCRIPTION OF DRAWINGS

FIG. 1 is a block diagram showing a charge management system according to an embodiment of the present invention.

FIG. 2 is a flowchart showing the flow of steps of a charge management system according to an embodiment of the present invention.

### DETAILED DESCRIPTION OF EMBODIMENTS

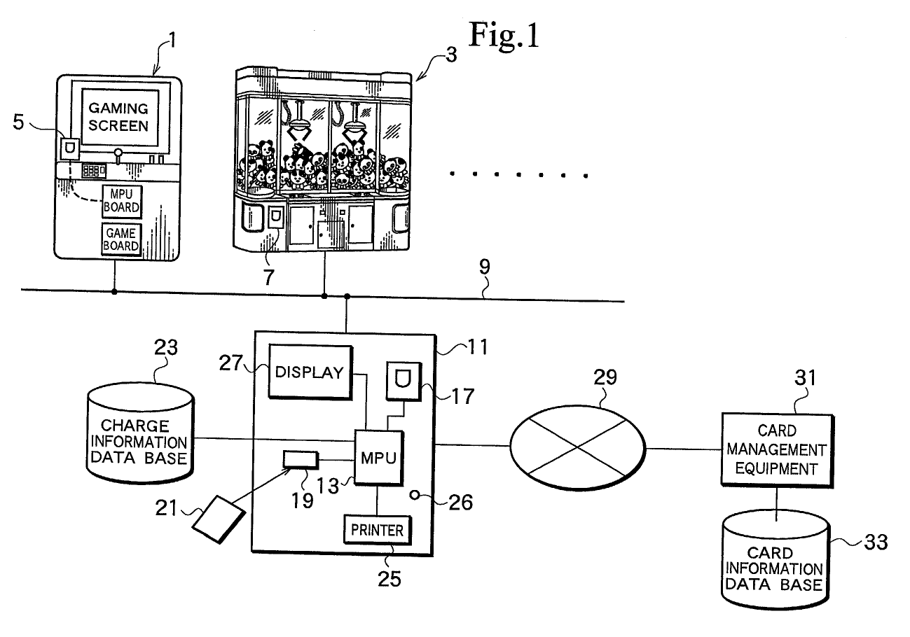

FIG. 1 shows a charge management system according to an embodiment of the present invention. Game machines 1, 3 constituting objects of operation are respectively installed in amusement arcade. These game machines 1, 3 are for example respectively different game machines, and may consist of different types or may be plural in number. However, the game machines 1, 3 are not limited to machines of different types or a plurality of machines but may consist of only a machine. Each game machine 1, 3 is equipped respectively with a fingerprint inputting section 5, 7 as a bio-information information inputting section for inputting the bio-information of the player who operates the machine. In other words, in this embodiment the bio-information takes the form of the fingerprint information of for example the forefinger of the player. However, it is possible to choose for example the eyes information, the face information, DNA, voiceprint, or the vein on the hand palm information for the bio-information of the player.

Each of the game machines 1, 3 is connected through wire through a transmission path 9 via LAN with a game machine manager 11. However, it is also possible to connect via wireless LAN each of the game machines 1, 3 and the game machine manager 11. And the form of the LAN connection is not limited to the bus network type but may be the ring network type.

The game machine manager 11 is provided with a MPU 13 as a processing means connected via LAN with each of the game machines 1, 3. The MPU 13 is provided with a fingerprint information registration section 17 as a bio-information registration section and a card information inputting section 19 as an inputting section of card information.

The fingerprint information registration section 17 is for inputting the fingerprint information of the player as his or her bio-information, which input signal is inputted into the MPU 13 for the registration of his or her fingerprint information.

The card information inputting section 19 includes a slot for inserting for example a credit card 21 for a card, the card information of which is read by a card reader, and the signal read thereby is inputted in the MPU 13. At this time, a password number is also inputted.

The credit card 21 may be in the form of a magnetic card or an IC card. In the case of an IC card, reading of the card information may be either of the contact type or the non-contact type.

The MPU 13 is furthermore connected with a charging information data base 23. The charging information data base 23 stores the charging information of the game machines 1, 3. The charging information may be ones set for each game machine 1, 3 at for example 100 yens, 200 yens, 300 yens, or the like by a single operation. The charging information data base 23 is designed to store always the latest charging information as its charging information is always stored or deleted in response to any addition or deletion of the game machines 1, 3. The frequency of using the game machine is set by pushing on the frequency setting button provided on each game machine 1, 3.

In addition, the game machine manager 11 is provided with a printer 25. The printer 25 is connected with the MPU 13 and prints out the charge result in the form of a voucher for the information of the player.

Moreover, the game machine manager 11 is provided with a display 27. The display 27 is designed to display the card information inputted by the card information inputting section 19, the fingerprint registered by the fingerprint registration section 17 and the like. The display 27 is also designed to display the charge result when the player pushes on a settlement button 26 for the issuance of a voucher by a printer.

The MPU 13 of the game machine manager 11 is connected communicably with a card manager 31 through the phone line network 29. The card manager 31 is managed by a card company. The card manager 31 is connected with a card information data base 33. The card information data base 33 stores the card information of the credit card 21. The card information consists of the name, age, address, password number of the registered individual and the like. The card information data base 33 is designed to be renewable whenever there is a new cardholder or a seceder and therefore the latest information is always stored therein.

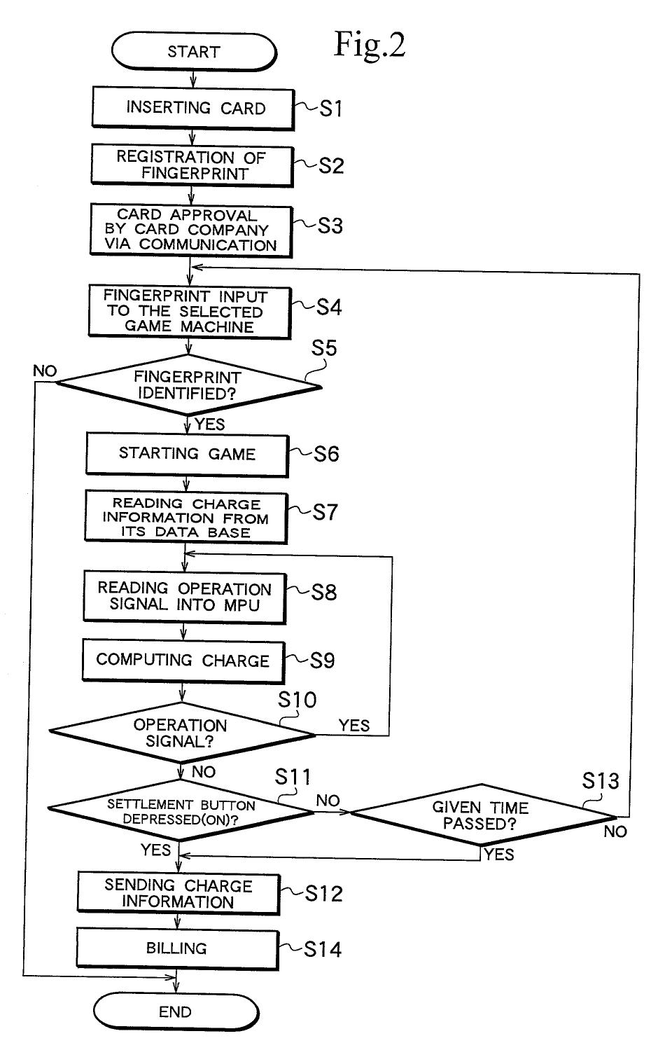

The operation of this invention is described below by referring to the flowchart shown in FIG. 2.

In Step S1 to begin with, the card is inserted. In other words, a credit card 21 is inserted into the slot of the card information inputting section 19 (FIG. 1), so that the card information signal inputted may be inputted into the MPU 13. This card information is displayed on the display 27 so that the player may be able to confirm the card information inputted.

In Step S2, the fingerprint is registered. In this fingerprint registration process, when the fingerprint information is inputted by applying the forefinger on the fingerprint information registration section 17, the read signal is inputted in the MPU 13 so that the fingerprint information may be registered. This fingerprint information is displayed on the display 27 so that the player may be able to confirm that his or her fingerprint has been registered.

In Step S3, a communication with the card company is executed and an approval is given therefrom. In other words, the card information inputted is sent from the MPU 13 to the card manager 31 of the card company through the phone line network 29. The card manager 31 collates the card information that has been transmitted with the card information read from the card information data base 33, and when the collated results agree, an approval signal is sent from the card manager 31 to the MPU 13.

In Step S4, the fingerprint is inputted in the game machine. In this fingerprint inputting process in the game machine, the player chooses any one of the game machine 1, 3 according to his or her preference to input his or her fingerprint by the fingerprint inputting section 5, 7.

In Step S5, the question of whether the fingerprint agrees or not is determined. The fingerprint information inputted by any one of the fingerprint information inputting sections 5, 7 and the fingerprint information inputted and registered by the fingerprint information registration section 17 are collated to determine whether they agree or not. When they agree the process moves to Step S6, and when they do not the process is terminated. In other words, unless the fingerprint information agree, none of the game machines 1, 3 can be operated.

When the fingerprint information agrees, in Step S6 the game start operation is executed, and an operation approval signal is transmitted from the MPU 13 to any one of the game machines 1, 3 into which the fingerprint information is inputted to bring any one of the approved game machines 1, 3 into an operable condition. Therefore, the player can start the operation of any one of the game machines 1, 3 into which his or her fingerprint information has been inputted simply by pushing on the frequency setting button.

In Step S7, the read operation of the charging information data base is executed. In this process, the charging information provided by the charging information data base 23 is read.

In Step S8, the read operation of the operating signal is executed. When the player pushes on any one of the frequency setting buttons provided on the game machines 1, 3, the corresponding signal will be read into the MPU 13.

In Step S9, the charge computing operation is executed. In accordance with the charging information read and the operation frequency signal, the game machines 1, 3 are charged by the MPU 13.

In Step S10, the question of whether there is any operating signal is determined. When the operation of the game machines 1, 3 has been started and when there is an operating signal, it is determined that the game can be continued, and the reading of the operating signal described in Step S8 and the charge computing described in Step S9 are repeated. When there is no operating signal, the process moves to Step S11.

In Step S11, the question of whether the settlement button is ON or not is determined. In this process, the question of whether the settlement button 26 has been pushed on or not is determined. When the button has been pushed on, the process moves to Step S12, and when the button has not been pushed on, the process moves to Step S13.

In Step S12, the charge information is transmitted, and the charge result accumulated until that moment is transmitted en bloc through the phone line to the card manager 31 of the card company. Upon receipt of the charge result, the card company executes the charging operation for each player and charges each player at the end of each session. The manager of the game machines 1, 3 shall be paid a fee less the commission of the card company.

When the settlement button 26 is pushed, the charging result will be displayed on the display 27 enabling the player to confirm instantly the charging result. When the settlement button 26 is pushed again, in Step S14, the operation of issuing a voucher is executed, and when the operation of the printer is started, a voucher showing the charging result will be issued enabling the player to obtain the charging result in the form of a voucher.

When in the Step S11 it is determined that the settlement button 26 has not been pushed and the process moved to Step S13, the question of whether a certain length of time has elapsed or not will be determined. This determination of whether a certain length of time has elapsed or not is intended to determine whether a certain length of time has elapsed while the player who had inputted his or her fingerprint from any one of the fingerprint inputting sections 5, 7 neglected completely to operate the game machines 1, 3, and to proceed with the charging operation even when the game machines are left abandoned without operating and to terminate the process. Therefore, if a certain length of time has not elapsed, the process after Step S4 will be executed again, and if a certain length of time has elapsed, it will be determined that the operator has forgotten to push on the settlement button 26 and the process will move to Step S12, where the charging information will be transmitted as mentioned above. This certain length of time is not specially limited, but may be 30 minutes, one hour or such other length of time during which the player may be determined to have forgotten to push on the settlement button 26.

Thus, in the embodiment of the present invention, once the player has inputted the card information and registered his or her fingerprint on the game machine manager 11, the player can start the game simply by inputting his or her fingerprint on each of the game machines 1, 3 and by pushing on the frequency setting button, eliminating thus the necessity of taking out his or her credit card every time, and inputting the card information and the password number, and the whole operation will become very simple.

Moreover, when the game machine 1, 3 to be operated is changed, there is no need to take out the credit card 21 every time, reducing thereby considerably the risk of losing the credit card 21.

In addition, in the aforementioned embodiment, the charging result is transmitted en bloc to the card manager 31 when the settlement button 26 is pressed. However, independently of the operation of the settlement button, the present invention may be configured in such a way that the charging result is transmitted to the card manager 31 every time when each of the game machines 1, 3 is operated. And the object of operation need not to be limited to game machines but may be extended to include coin-operated lockers, coin-operated laundry and other equipment requiring charge management. Moreover, the present invention may be configured in such a way that the game machine manager 11 is provided with a fingerprint inputting section, by means of which the fingerprint information is inputted and the player authorized to push on the settlement button is specified, and the charging result for the specified player alone may be transmitted to the card manager 31.

What is claimed is:

1. A charge management system, comprising:
an object or objects of operation comprising a bio-information inputting section for inputting the bio-information of the operator;
a processing means connected through wire or by radio with the object or objects of operation;
a bio-information registration section connected with the processing means for registering the bio-information of the operator, and a card information inputting section for inputting card information;
a charging information data base connected with the processing section for storing the charging information of the object or objects of operation;
a card manager capable of communicating through phone line with the processing means; and
a card information data base connected with the card manager for storing the card information,
wherein the card information inputted and the bio-information registered in the processing means are transmitted to the card manager to be collated with the card information contained in the card information data base, the processing means brings the object or objects of operation into an operable condition when an approval signal is transmitted from the card manager to the processing equipment based on the result of the collation and when the bio-information inputted in the bio-information inputting section of the object or objects of operation agrees with the registered bio-information, and the charge management system charges the operator based on the charging information in response to the operating information of the object or objects of operation and transmits the charge result to the card manager.

2. The charge management system according to claim 1, wherein
the objects of operation are of plural types and are plural in number.

3. The charge management system according to claim 1, wherein
the bio-information consists of the fingerprint information of the operator.

4. The charge management system according to claim 2, wherein
the bio-information consists of the fingerprint information of the operator.

5. The charge management system according to claim 1, wherein
the processing means transmits the charge results every time or collectively.

6. The charge management system according to claim 2, wherein
the processing means transmits the charge results every time or collectively.

7. The charge management system according to claim 3, wherein
the processing means transmits the charge results every time or collectively.

8. The charge management system according to claim 1, wherein
a printer is connected with the processing means to print out the charge results for the information of the operator.

9. The charge management system according to claim 2, wherein
a printer is connected with the processing means to print out the charge results for the information of the operator.

10. The charge management system according to claim 3, wherein
a printer is connected with the processing means to print out the charge results for the information of the operator.

11. The charge management system according to claim 4, wherein
a printer is connected with the processing means to print out the charge results for the information of the operator.
